(19) United States
(12) Patent Application Publication
(10) Pub. No.: US 2006/0285655 A1
(43) Pub. Date: Dec. 21, 2006

(54) PACKAGE TRACKING AND NOTIFICATION SYSTEM FOR A MAIL AND PARCEL CENTER

(76) Inventor: Vincent D. Little, West Bloomfield, MI (US)

Correspondence Address: ARTZ & ARTZ, P.C., 28333 TELEGRAPH RD., SUITE 250, SOUTHFIELD, MI, 48034, US

(21) Appl. No.: 10/908,750

(22) Filed: May 25, 2005

(51) Int. Cl. H04M 1/64

(52) U.S. Cl. 379/67.1

(57) ABSTRACT

A package tracking system (10) for a mail and parcel center (12) having multiple client mailboxes (18) includes a data entry device (56). The data entry device (56) receives package information associated with a client mailbox (18) upon arrival of a package (54) to the mail facility (12). A processor (58) is coupled to the data entry device (56) and generates a package arrival indication signal in response to the package information. A telecommunication device (60) is coupled to the processor (58) and transmits the package arrival indication signal to a client associated with the client mailbox (18).

### TECHNICAL FIELD

The present invention is related generally to package tracking systems. More particularly, the present invention is related to a system and method of tracking packages and informing recipients of those packages upon their arrival to a mail facility.

### BACKGROUND OF THE INVENTION

A mail and parcel facility/center, such as The UPS Store™, a FedEx/Kinkos® distribution facility, or a United States Postal Service (USPS®) office, may contain hundreds to thousands of client mailboxes. As incoming mail is received, with respect to clients of those mailboxes, a mailroom manager places the mail in the clients' respective mailboxes. The mailboxes tend to have limited space. Thus, when packages arrive that are too large for the mailboxes the packages must be stored elsewhere. The mailbox placement, storage, and tracking of the mail and packages are laborious and tedious processes. Often times, clients are unaware that they have mail or a package to pick up prior to calling or visiting the center.

When a package arrives that is too large for a designated client mailbox, the mailroom manager may note in a logbook that the package has arrived, time and date that the package arrives, storage location of the package, and client information including mailbox number. The logging of packages is time consuming and laborious, especially in a center that contains hundreds to thousands of mailboxes. The logbook can deteriorate and tends to become “messed-up” over time.

The mailroom manager in addition to filling out the logbook and storing a received client package also is required to fill out a notification form, which is to be placed in the client mailbox. The notification form indicates to the client that a package has arrived. The associated disadvantage with this notification is that unless the client checks the mailbox daily, several weeks may pass before the client becomes aware that a package has arrived. A client does not become aware of the arrived package until the client opens the mailbox and receives the notification form placed therein. As a result, storage and insurance costs of the packages can be considerable.

Also, in utilizing the above-described process packages can often get lost or misplaced or it can become difficult to identify the location of the package because the original identification information (i.e. Mail Box/PO number) is small, missing, or unreadable. The logbook and the notification forms may contradict one another as to the location of the package. In addition, customers tend to become irritated when waiting for a mailroom manager to look up package information in the logbook and then to locate the package in the mail center.

Thus, there exists a need for an improved mail and package tracking system and method of notifying mailbox customers when mail and packages have arrived.

### SUMMARY OF THE INVENTION

An embodiment of the present invention provides a package tracking system for a mail facility that has multiple client mailboxes. The system includes a data entry device. The data entry device receives package information associated with a client mailbox upon arrival of a package to the mail facility. A processor is coupled to the data entry device and generates a package arrival indication signal in response to the package information. A telecommunication device is coupled to the processor and transmits the package arrival indication signal to a client associated with the client mailbox. Similar information may also be available and accessible on a web site.

The embodiments of the present invention provide several advantages. One such advantage is the provision of indicating to a client the arrival of mail and packages, to a mail facility, via a telecommunication signal and web site. This indication allows for quick notification of package arrival and shortens the package storage time, which increases client satisfaction in mail facility services and decreases operating costs of the mail facility

Another advantage provided by an embodiment of the present invention, is the provision of systematic package information entry, logging, and tracking. This also increases mail facility operating efficiency and decreases operating costs.

Yet another advantage provided by an embodiment of the present invention, is the provision of systematic package label and/or ticket generation. This aids in identifying packages themselves, package storage locations, and mailboxes. This also eliminates the need for filling out notification forms and further increases operating efficiency.

Still another advantage provided by an embodiment of the present invention, is the provision of generating “aging” reports, marketing ads, mail facility update notifications, billing reports, bills, and other informative documents in response to stored package related information. This increases operating efficiency, alerts clients of various mail facility services, decreases billing turn around time, and can increase the amount of business a facility receives.

The present invention itself, together with further objects and attendant advantages, will be best understood by reference to the following detailed description, taken in conjunction with the accompanying drawing.

Other features, benefits and advantages of the present invention will become apparent from the following description of the invention, when viewed in accordance with the attached drawings and appended claims.

### BRIEF DESCRIPTION OF THE DRAWINGS

For a more complete understanding of this invention reference should now be made to embodiments illustrated in greater detail in the accompanying figures and described below by way of examples of the invention wherein:

FIG. 1 is a schematic and block diagrammatic view of a package tracking and notification system in accordance with an embodiment of the present invention.

FIG. 2 is a schematic and block diagrammatic view of a mail facility internal notification system in accordance with another embodiment of the present invention.

FIG. 3 is a front view of a mailbox label/ticket in accordance with an embodiment of the present invention.

FIG. 4 is a logic flow diagram illustrating a method of tracking and indicating arrival of packages within a mail facility and in accordance with an embodiment of the present invention.

### DETAILED DESCRIPTION

In the following Figures the same reference numerals will be used to refer to the same components. While the present invention is described primarily with respect to tracking and indicating the arrival of packages within a mail and parcel center, the present invention may be adapted and applied to various applications. The present invention may be applied to mail facilities, schools/university mail facilities, business/corporation mail facilities, public or private mail facilities, government operated mail facilities, and other facilities wherein the tracking and notification of packages is desired. Also, a variety of other embodiments are contemplated having different combinations of the below described features of the present invention, having features other than those described herein, or even lacking one or more of those features. As such, it is understood that the invention can be carried out in various other suitable modes.

In the following description, various operating parameters and components are described for one constructed embodiment. These specific parameters and components are included as examples and are not meant to be limiting.

Also, in the following description the terms “client” and “customer” may refer to both a mailbox client or customer and a non-mailbox client or customer. Clients may lease one or more mailboxes or utilize a facility for other purposes and services. These purposes and services may include the purchasing of products, the providing of mail services, the providing of software or hardware services, or other services known in the art.

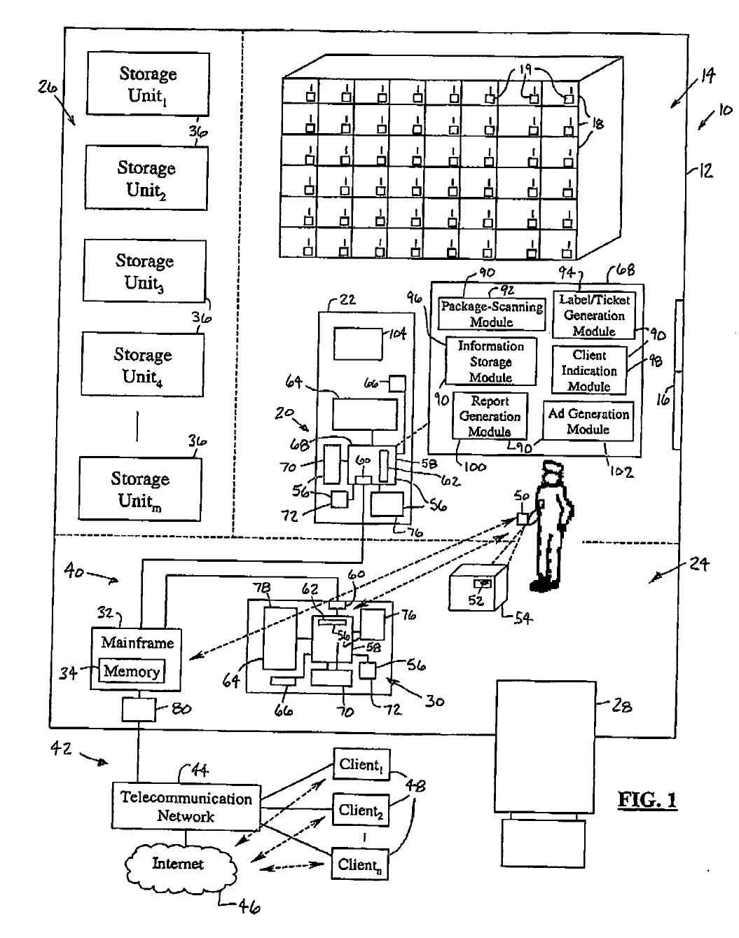

Referring now to FIG. 1, a schematic and block diagrammatic view of a package tracking and notification system 10 in accordance with an embodiment of the present invention is shown. The package system 10 is shown as being applied in relation to a postal/mail facility 12. The mail facility 12 may be in the form of an alternate delivery location or a final package delivery location. An alternate delivery package location is a location that accepts packages destined for another location. However, one skilled in the art would recognize the ability of the package system 10 to be utilized in relation to various other facilities, some of which mentioned above. The mail facility 10 includes a main entrance area 14 that is accessible through doors 16. The main area 14 has mailboxes 18 having identification codes or labels (not shown) thereon. Each mailbox 18 is associated with a particular client and is used to store client mail until pick up by that particular client. Each mailbox 18 may have an access key mechanism or other locking mechanism 19 for security purposes, of which only a mail facility staff member or the client may possess the key or code for access. The main entrance area 14 includes a first sub-package tracking system 20 that is located on a reception table 22.

The mail facility 12 also includes a package reception area 24 and a package storage area 26. The package reception area 24 allows for the reception of packages via trucks, such as truck 28. The package reception area 24 includes a second sub-package tracking system 30 and a main control and storage center 32, which for example purposes is shown as a mainframe having a memory 34. The second tracking system 30 is similar to the first tracking system 20. The package storage area 26 includes multiple storage units 36, which may be in the form of shelves, cabinets, lockers, or other package storage units known in the art. The storage units 36 store packages that are too large to fit into the mailboxes 18.

The package system 10 includes an internal network 40 and an external network 42. The external network 42 includes a telecommunication network 44, which has access to the Internet 46. The telecommunication network 44 and the Internet 46 may be in communication with various clients 48. The internal network 40 may be in the form of an Intranet and may include web servers, storage/memory units, load balancing and filter devices, ad servers, modems, and other internal network componentry and devices known in the art. The internal network 40 may, for example, be connected via Ethernet connections. The external network 42 may include the Internet 46, as shown, as well as, central offices, modems, hubs, and other interactive communication facilities, ports, and junctions known in the art. The external network 42 may be in the form of an integrated services digital network, a digital subscriber network, a wireless network, or other external network known in the art. The networks 40 and 42 may include a local area network, a wide area network, a personal area network, a campus area network, a metropolitan network, and other networks known in the art. The networks 40 and 42 may be analog or digital based and operate via various known wired and wireless protocols known in the art, such as bluetooth and wireless fidelity, and may follow various Institute of Electronic and Electrical Engineers (IEEE™) standards.

The package system 10 includes the tracking systems 20 and 30, which may be coupled to and are in communication with the main center 32. The tracking systems 20 and 30 may be in wired or wireless communication with the main center 32. The package system 10 may also include wireless handheld scanning and tracking devices, such as the handheld device 50. The handheld device 50 may be considered a sub-package tracking system and may be utilized anywhere within the mail facility 12 and within active communication range with the tracking systems 20 and 30 and main center 32. In one example operative embodiment, the handheld device 50, using infrared technology or other scanning technology, scans a bar code 52 and other identification information from a package 54 and transfers that information to the second tracking system 30. Packages may be received through a mail service or directly from clients.

The tracking systems 20 and 30 and the handheld device 50 may include various data entry devices 56, controllers/processors 58, telecommunication devices 60, monitors or indicators 62, printing devices 64, and signature pads 66 (the stated devices are not shown for the handheld device 50). The data entry devices 56 may for example include keypads, keyboards, touch screens, mouses, scanners, bar code readers, etc. The tracking systems 20 and 30 as shown include a computer 68, a keyboard 70, a mouse 72, a screen 74, a bar code reader 76, and a printer 78. Although the tracking systems 20 and 30 are shown as having access to the Internet 46 through the main center 32, they may also or as an alternative have direct access to the Internet 46. The handheld device 50 may have access to the Internet 46 directly or through the main center 32.

The main center 32 may be in the form of a mainframe as shown, or may be in the form of some other centrally located and/or remotely accessible processing unit. The main center 32 may be located on site and within the mail facility 12 or may be located off site, such as within a central office. Multiple mail facilities may have access to the main center 32. The main center 32 may include one or more modems 80 and other telecommunication network accessing equipment, as known in the art. Information stored in the memory 80 may be stored in tubular form.

The tracking systems 20 and 30, the main center 32, and the handheld device 50 may be in wired or wireless communication with each other. They each may have the appropriate transmitters and receivers for such communications.

The main center 32 and the processors/controllers 58 may each be microprocessor based and have central processing units, memory (RAM and/or ROM), and associated input and output buses. The main center 32 and the processors/controllers 58 may be in the form of application-specific integrated circuits or may be formed of other logic devices known in the art. The main center 32 and the processors/controllers 58 may be combined into a single integrated controller, or may be stand-alone controllers as shown.

The main center 32, the handheld device 50, and the processors/controllers 58 may each contain multiple modules 90, which may be software or hardware based. Some example modules are shown for the first tracking system 20 and include a package-scanning module 92, a label/ticket generation module 94, an information storage module 96, a client indication module 98, a report generation module 100, and an ad generation module 102.

The package-scanning module 92 is utilized when packages are received and picked up to read information thereon. The label/ticket generation module 94 is utilized to generate labels and/or tickets for placement on or in storage units 36, packages, such as package 54, a logbook 104, and mailboxes 18 for quick and easy locating of packages and for indication to clients of the arrival of the packages. The logbook 104 may be used for “hard” draft purposes, although the information logged therein is accessible from the tracking systems 20 and 30 and handheld device 50 and stored in the memory 80.

The information storage module 96 is utilized in storing package, client, package storage, mailbox, facility, and other related information in a desired format, which can be readily accessible to the tracking systems 20 and 30, the main center 32, and the handheld device 50. The client indication module 98 is used to alert, indicate, and inform a client of package arrival and to remind a client when a package has previously arrived and has not been picked up. The report generation module 100 is utilized to generate inventory, billing, and other facility related reports. The ad generation module 102 is utilized to generate marketing ads, update messages of facility services and changes, and other facility related messages.

The facility 12 may generate ads or service updates and communicate these ads and updates to the clients via the telecommunication network 44. These messages may be communicated in a nonverbal or verbal format through email or computer generated voice communication. The facility 12 may also provide software services. For example, the modules 90 may be in a software package, which may be updated periodically. The software package may be stored on the main center 32 and may be accessible and downloadable to other facilities.

Although the above-described tracking system is described in relation to the scanning of packages by a staff member, the tracking system may be automated. Upon arrival, packages may be placed, loaded, or transported onto conveyers and scanned while being transported to a mailbox or storage area. Of course, various automated package-transporting systems known in the art may be incorporated.

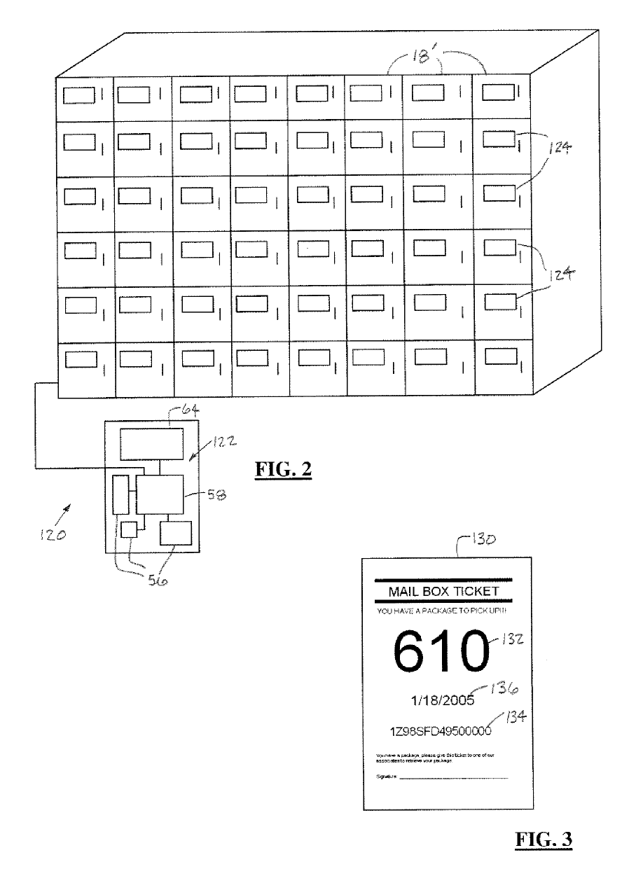

Referring now to FIG. 2, a schematic and block diagrammatic view of a mail facility internal notification system 120 in accordance with another embodiment of the present invention is shown. The notification system 120 includes a package tracking and notification system 122 that is similar to the package system 10 and the tracking systems 20 and 30. The package system 120 is in communication with the mailboxes 18′ and provides package related information to the appropriate client mailboxes 18′ via indicators 124. The package system 120 may be in wired or wireless communication with the mailboxes 18′. When a package arrives that does not fit in the associated mailbox 18′, the package is scanned by the package system 120 and a package arrival signal is generated and indicated on the associated mailbox indicator 124. A similar indication may also be provided when mail is placed within the mailbox. This eliminates the need for the generation of mailbox labels and/or tickets.

The indicators 124 may be located on the mailboxes 18′, as shown, or within the mailboxes 18′. The indicators 124 may be in the form of a video system, an audio system, one or more LEDs, a seven-segment display, an LCD display, one or more lights, a combination thereof, or may be in the form of some other indicator known in the art.

Referring now to FIG. 3, a front view of a mailbox label/ticket 130 in accordance with an embodiment of the present invention is shown. The mailbox label/ticket 130 may be placed within or have adhering qualities as to stick to a mailbox. The mailbox label/ticket 130 may be in the form of a self-stick note. The mailbox label/ticket 130 may include a mailbox number 132, a package identification code 134, a package arrival date 136, a storage location (not shown), and other related information. The mailbox label/ticket 130 may also be signed by a facility staff member. This same information may also be provided over the telecommunication network to a client.

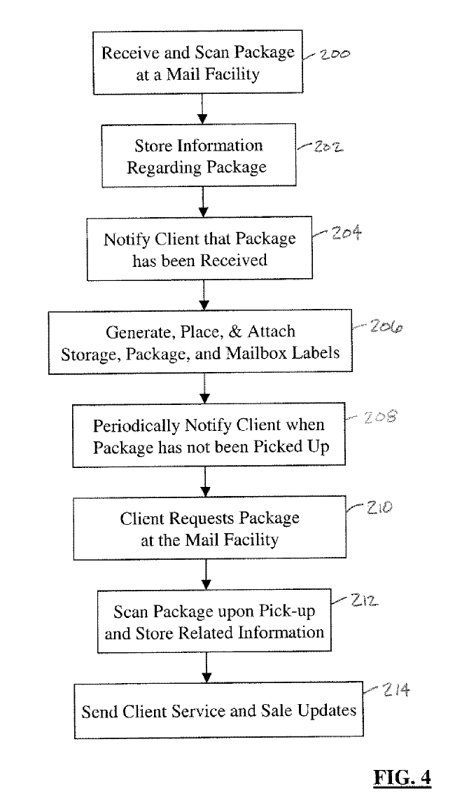

Referring now to FIG. 4, a logic flow diagram illustrating a method of tracking and indicating arrival of packages within a mail facility and in accordance with an embodiment of the present invention is shown. Although the following steps are primarily described with respect to the embodiments of FIGS. 1-3, they may be easily altered to apply to other embodiments of the present invention.

In step 200, upon arrival, a package is scanned by a tracking system, such as by the handheld device 50 or one of the tracking systems 20, 30, or 122. Barcodes or other information may be scanned off of the package and entered into the package system. When mail is received that is to be placed within a client mailbox, prior to such placement a barcode on the mailbox or elsewhere that identifies the client mailbox may be scanned.

In step 202, the scanned information as well as the time and date of arrival are stored into one or more memories in the package system, such as the memory 34. The package system may store client or customer information, package information, mailbox information, e-mail addresses, storage information, arrival time and date information, and other related information known in the art. Customer information includes customer name, contact information, such as address, phone number, email address, and other contact information, billing history and information, and other customer information known in the art. Package information includes sender information, recipient information, size, weight, whether the package is first class, ground, certified, or other mailing class identification, fragile, or any other package information known in the art. Mailbox information and storage information includes isle, shelve, slot, column, row, box, key number, password, and other location identification and access information.

In step 204, the package system in response to the received information notifies the client via an external network, such as network 42, that the package or that mail has arrived and is ready to be picked up. The package system emails the clients even when the system printers, such as printers 78, are out of labels, or the printing feature is turned off, assuring notification to the clients. The package system may be used to print out letters, which may be mailed (e-mail) to the clients. The package system may also be used to call the clients, via a phone service to leave a message with the clients directly or on their answering machine. The package system may post package arrival information on a web site, which may be accessible by the clients. The package system may in addition generate and print mailings, such as post cards, having the relevant information that may be mailed to the client.

In step 206, the package system also in response to the received information generates one or more label/tickets, such as ticket 130. The labels/tickets may be placed on or in storage units, mailboxes, packages, logbooks, or elsewhere. The labels/tickets may include bar codes and other package, mailbox, and client identifying information.

In step 208, the package system may periodically notify a client when a package has not been picked up. The package system may generate aging reports identifying packages that have not been picked up over a predetermined amount of time. The tracking system or a facility staff member may review the reports and then take the appropriate actions necessary to further alert the client of the package. The package system may generate additional tickets to be placed within the client's mailbox, indication signals on the mailbox, mailings, or send package update signals to the client via the external network. The client may be notified that the package is to be returned to the sender if the package is not picked up by a certain date.

In step 210, when the client arrives at the facility to pickup the package, the client can request the package from a mailbox manager or staff member. The manager may look up the client using client information or a client identification card, such as the ticket that was placed in the client mailbox or that was printed by the client using a facility computer, a home computer, or other computer that receives notification of the package arrival or has access to the main center. The manager may also scan the client identification card or the label, provided to the client, to find the package quickly. The mailbox manager may enter various information and/or comments into the computer, which may be stored and tagged or associated with a particular client. The entered information and comments may also be or have been printed on the labels and communicated to client via the external network.

In step 212, the package is then located and scanned. The system notes the time and date of the pickup and stores signature of the client. The client may sign an electronic signature pad, the ticket that was placed in their mailbox, a logbook, a receipt, or other form of indication signifying that the package has been picked up.

In step 214, the package system may generate other business related ads, updates, notifications, or reports, which may be viewed by a staff members, printed, placed within the mailboxes, indicated on the mailboxes, or communicated to clients via the external network or some other known communication medium. The package system may, for example, generate marketing ads, mail facility update notifications, billing reports, bills, and other facility related communications.

The above-described steps are meant to be illustrative examples; the steps may be performed sequentially, synchronously, simultaneously, or in a different order depending upon the application.

The present invention provides an efficient and inexpensive package tracking and client notification system for a mail and parcel facility. The present invention systematically alerts clients upon the arrival of packages and provides a periodic reminder of that arrival.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. A package tracking and notification system for a mail facility having a plurality of client mailboxes, the system comprising:
at least one data entry device remotely located from said plurality of client mailboxes and within the mail facility receiving package information associated with at least one of the plurality of client mailboxes upon arrival of at least one package to the mail facility and prior to placement of said at least one package in a designated storage location in the mail facility;
a processor coupled to said data entry device and generating at least one package label for placement on said at least one package, and a package arrival indication signal in response to said package information; and
a telecommunication device coupled to said processor and transmitting said package arrival indication signal to at least one client associated with said at least one client mailbox.

2. A system as in claim 1 further comprising a memory, said processor coupled to said memory and storing information selected from at least one of: customer information, package information, mailbox information, storage information, and time and date information.

3. A system as in claim 1 wherein said at least one data entry device is selected from at least one of: a mouse, a keypad, a keyboard, a scanner, a bar code reader, a wireless device, and a handheld device.

4. A system as in claim 1 further comprising at least one mailbox indicator coupled to said processor and indicating to said at least one client said package arrival indication signal.

5. A system as in claim 4 wherein said at least one mailbox indicator is coupled to said at least one mailbox.

6. A system as in claim 1 further comprising a printing device, said processor coupled to said printing device and generating at least one mailbox ticket for placement in said at least one mailbox.

7. A system as in claim 1 further comprising a printing device, said processor coupled to said printing device and generating said at least one package label having package related information at the mail facility.

8. A system as in claim 1 wherein said processor generates at least one of a storage location label, a mailbox label, and a logbook label.

9. A system as in claim 8 wherein said at least one label comprises at least one bar code.

10. A system as in claim 1 wherein transmitting said package arrival indication signal to at least one client comprises digital or analog telecommunication to at least one client receiver.

11. A system as in claim 1 wherein transmitting said package arrival indication signal to at least one client comprises sending an email notification.

12. A system as in claim 1 wherein said package arrival indication signal is transmitted over at least one medium selected from: a phone line, a digital cable line, a cell phone network, an Internet.

13. A system as in claim 1 wherein said processor comprises a plurality of modules.

14. A system as in claim 13 wherein said plurality of modules comprises at least one of a package scanning module, an information storage module, a client indication module, a report generation module, an ad generation module, and a label generation module.

15. A method of tracking and indicating arrival of packages within a mail facility comprising:
receiving mail within a mail facility comprising a plurality of client mailboxes;
entering data associated wit said mail in a package tracking system prior to placement of said mail in said plurality of client mailboxes and via a data entry device that is external to said plurality of client mailboxes and; and
electronically notifying at least one client mailbox recipient of the arrival of said mail, mailbox information, and storage information.

16. A method as in claim 15 wherein said notification is performed via at least one of said mailbox, an email message, a phone message, a telecommunication message, and a posting on a website.

17. A method as in claim 15 further comprises generating at least one label having package related information in response to said data.

18. A method as in claim 15 further comprising generating at least one of: an aging report, a marketing ad, a mailbox facility business update notification, a billing report, and a bill in response to said entered data.

19. A mail facility comprising:
a plurality of client mailboxes; and
a package tracking system comprising;
at least one data entry device, detached from said plurality of client mailboxes, receiving package information associated with at least one of the plurality of client mailboxes after removal of at least one package from said plurality of client mailboxes; and
at least one processor coupled to said data entry device and generating an indication signal in response to said package information, said at least one processor updating client mailbox information in response to said indication signal.

20. A facility as in claim 19 further comprising a package storage area, said processor indicating storage location of said at least one package in said package storage area.

21. A system as in claim 1 wherein said processor generates said at least one package label comprising storage location information, a tracking number, and a date.

22. A method as in darn 15 further comprising generating at least one of: an aging report, a marketing ad, a billing report, and a bill in response to said entered data and electronically notifying said at least one client mailbox recipient the same.

23. A package tracking and notification system for a mail facility having a plurality of client mailboxes, the system comprising:
at least one data entry device remotely located from said plurality of client mailboxes and within the mail facility receiving package information associated with at least one of the plurality of client mailboxes upon arrival of at least one untracked package to the mail facility and prior to placement of said at least one untracked package in a designated storage location in the mail facility; and
a processor coupled to said data entry device and generating at least one package label in response to said package information.

24. A system as in claim 23 further comprising a telecommunication device coupled to said processor and transmitting a package arrival indication signal to at least one client associated with said at least one client mailbox in response to said package information.
